(19) United States
(12) Patent Application Publication
(10) Pub. No.: US 2010/0150690 A1
(43) Pub. Date: Jun. 17, 2010

(54) Storage Lift

(76) Inventors: Mathias Braun, Hungen-Langd (DE); Jurgen Reissig, Marburg (DE)

Correspondence Address: Mark P Stone, 50 Broadway, Hawthorne, NY, 10532, US

(21) Appl. No.: 12/226,308

(22) PCT Filed: May 6, 2006
(86) PCT No.: PCT/EP2006/004246

§ 371 Date: Feb. 12, 2010

(30) Foreign Application Priority Data
Apr. 15, 2006 (DE) 20 2006 006 539.3

(51) Int. Cl. B65G 1/06; B65G 1/00

(52) U.S. Cl. 414/278

(57) ABSTRACT

In a storage lift comprising a plurality of shelf columns (3a, 3b) which lie next to one another and opposite one another on both sides of a conveying shaft (15), a horizontally displaceable support frame (18) for a conveyor (26) which is movable upwards and downwards is guided in the conveying shaft (15) on two guide rails (16, 17), of which one is connected fixedly to the base (23) of the conveying shaft (15) and one is arranged in the upper region thereof.

### TECHNICAL FIELD

The present invention relates to a storage lift comprising a plurality of shelf columns which lie next to one another and opposite one another on both sides of a conveying shaft, whose side walls are provided with support webs arranged at a small distance from each other and one above the other for supporting storage material carriers, a conveyor, which is vertically and horizontally movable in the conveying shaft and provided with a horizontal conveying means and guided in a support frame and by which storage material carriers can be transferred from at least one feeding and retrieving opening to and re-transported from storage places of the shelf columns positioned in a shelf column, and a respective light grid provided in the region of the feeding and retrieving opening for determining the height of the storage material to be stored in a height-optimized way.

### PRIOR ART

A storage lift of the aforementioned type is known from the company publication Shuttle XP and Shuttle Xplus with “Optiflex”, Shut/D/3/2000/06.04/BO-GWD. In the known storage lift the support frame which extends over the whole length of the conveying shaft is supported to be movable upwards and downwards on vertical guide rails in the region of the front walls facing each other of the housing of the storage lift, and its longitudinal legs extending in the longitudinal direction of the conveying shaft form guide rails for the conveyor which is horizontally movable on the support frame and which stores and also retrieves again the storage material in the manner known from DE 42 33 688 C2 with optimal exploitation of the available storage space, i.e. height-optimized. It is understood that with an increasing number of adjacently arranged pairs of shelf columns, especially when heavy goods are stored, the bending loads on the longitudinal legs of the support frame assume considerable values and that this fact must be taken into account by enlarging the cross sections or by way of auxiliary constructions of the type disclosed in DE 20 2005 017 269 U1. At any rate, the share of the weight of the vertically movable frame in the load to be lifted altogether when storage material is stored increases considerably with an increasing number of the adjacently arranged shelf column pairs. This means not more or less than an undesired high rise in both manufacturing costs and energy costs required for operating the storage lift.

### ILLUSTRATION OF THE INVENTION

It is the object of the invention to design the means used for storing and retrieving the conveying material used in a storage lift of the type under consideration such that their dimensions and manufacturing costs do not depend on the number of the adjacently arranged shelf columns.

The set object is achieved in a shelf of the aforementioned type according to the invention in that the conveyor is supported in a manner known per se to be movable upwards and downwards in the support frame and said support frame, on its part, is guided also in a manner known per se to be movable in horizontal direction on at least two guide rails, of which one is connected fixedly to the base of the conveying shaft and one is arranged in the upper region of the conveying shaft.

Since the guide rail supporting the support frame at the bottom is connected to the base of the conveying shaft, i.e. the base of the installation place, it takes the total weight of the support frame. The forces needed for horizontally moving the support frame are thus kept within a narrow limit. Since the dimensions of the support frame do not depend on the length of the conveying shaft, the number of the shelf columns to be fed can be adapted without any problems to the user's needs. Horizontally movable support frames with a conveyor that can be moved upwards and downwards have already been in use in open shelf systems for a long time. They comprise at least two vertical carriers and two horizontal carriers which interconnect said vertical carriers at the top and bottom and run in the direction of their travel, and their vertical carriers are provided with guides for the conveyor which is movable upwards and downwards thereinbetween and carries the storage material.

The reason why horizontally movable support frames have so far not been used in storage lifts comprising closed housings is probably due to the space required by the vertical carriers and to the drive elements positioned outside the vertical carriers and used for driving the support frame. This additionally required space is inconsistent with the practice common in storage lifts, i.e. to form the housing walls, which are arranged on the ends of the conveying shaft, more or less in alignment with the lateral outer walls of the respectively last shelf columns of a row of shelf columns so as to use the space available for the storage lift in an optimum way with storage material. However, as has been found, the loss in storage space caused by the use of the described support frame is certainly outweighed by the advantages offered by the horizontally movable support frame. This notably applies when the parts of the housing that complete the opposing ends of the conveying shaft are configured as maintenance shafts into which the vertical carrier of the support frame respectively facing the same is movable.

Further features and details of the storage lift according to the invention become apparent from the sub-claims and the following description of an embodiment shown in the attached schematic drawings.

### BRIEF DESCRIPTION OF THE DRAWINGS

FIG. 1 shows a front view of a storage lift with four pairs of shelf columns that are arranged side by side;

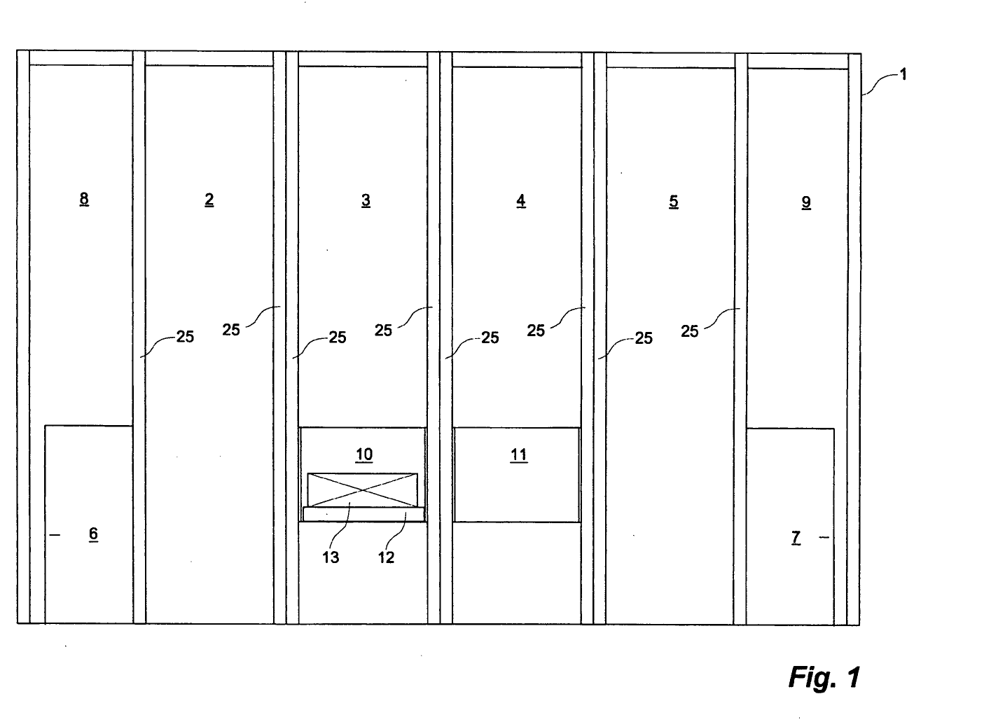

FIG. 2 shows a front view corresponding to FIG. 1 with a partially cut-away part of the housing of the storage lift;

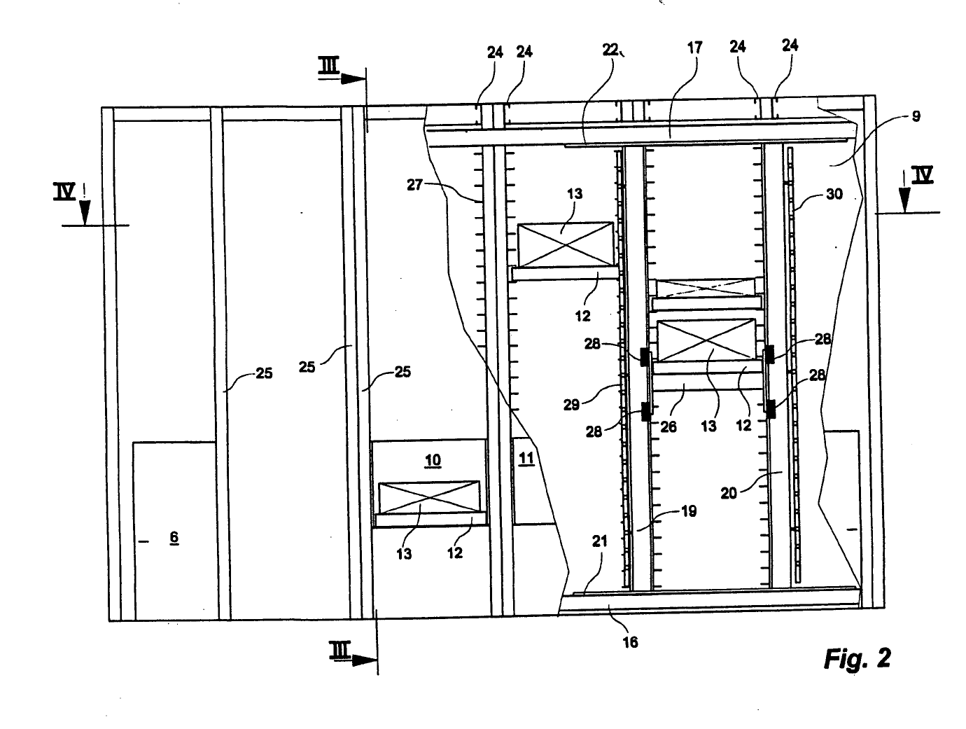

FIG. 3 shows a section taken along line III-III in FIG. 2; and

FIG. 4 shows a section taken along line IV-IV in FIG. 3.

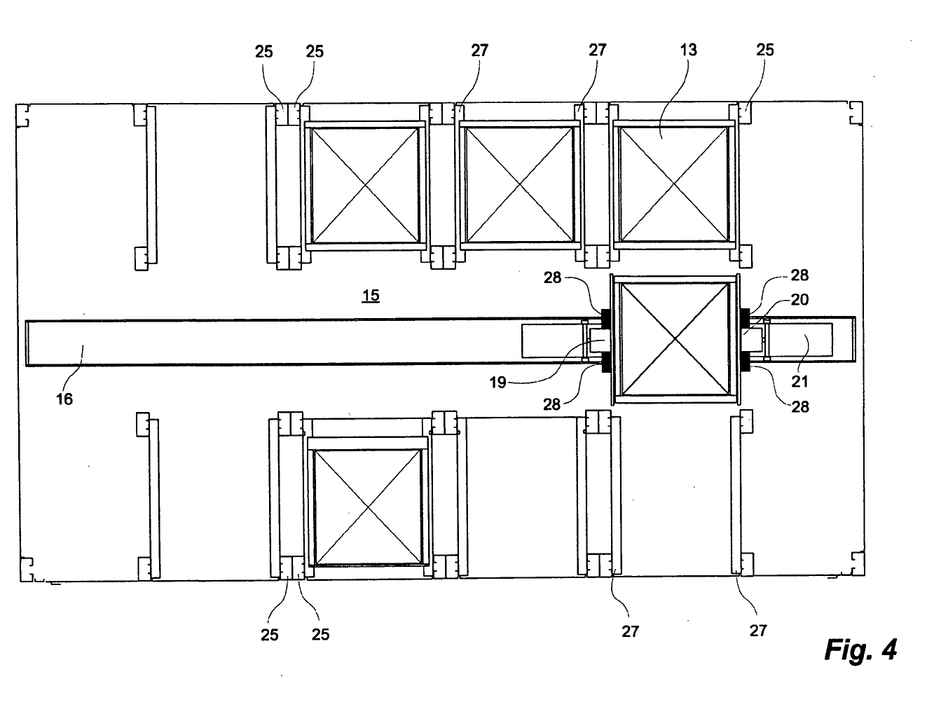

### WAYS OF IMPLEMENTING THE INVENTION

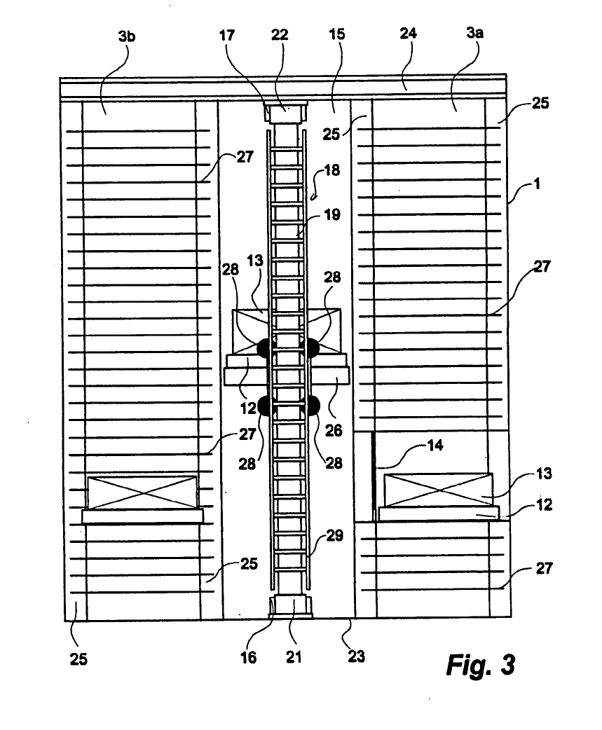

In the figures, 1 is the housing of a storage lift comprising four shelf column pairs 2, 3, 4 and 5. The storage lift is built modularly, i.e. it consists substantially of components that are also used in known single storage lifts. The lateral parts of the housing 1 form maintenance shafts 8 and 9 that are accessible through doors 6, 7. The front shelf columns 3a and 4a of the shelf column pairs 3 and 4 are each provided with a feeding and retrieving opening 10, 11 for storage material carriers 12 with storage material 13 of a varying height to be put in and removed from storage. As outlined in FIG. 3, the feeding and retrieving openings are equipped with a light grid 14 with the help of which the height of the respective storage material 13 to be stored is determined. It is ensured by a suitable identification and management software that the storage material 13 is stored such that the storage space available in the shelf columns 2 to 5 is used in an optimum way.

As shown by means of the shelf columns 3a and 3b of the shelf column pair 3 in FIG. 3, the shelf column pairs 2 to 5 confine a conveying shaft 15 which extends into the region of the maintenance shafts 8 and 9. In the conveying shaft 15 a support frame 18 which consists of two vertical carriers 19, 20 and two horizontal carriers 21, 22 running in the longitudinal direction of the conveying shaft 15 is guided by means of a lower guide rail 16 and an upper guide rail 17. While the lower guide rail 16 is firmly connected to the base 23 of the installation place by means of dowels, the upper guide rail 17 is held by transverse carriers 24, which interconnect the upper ends of corner posts 25 of the shelf columns 2 to 5.

A conveyor 26, which is also called extractor and which is equipped in the known way with a horizontal conveying means with the help of which storage material carriers 12 can be stored and retrieved is guided on the vertical carriers 19, 20 to be movable upwards and downwards. As is known from the above-mentioned DE 42 33 688 C2, the respective storage places are freely selectable. They are formed by support webs 27 which project into the interior of the shelf columns 2 to 5 and the mutual distance of which is smaller than the height of the storage material carrier 12. This distance is maximum 50 mm in practice.

At its opposing sides the conveyor 26 is provided with four respective guide rolls 28 with the help of which it is supported on the vertical carriers 19, 20 of the support frame 18.

The maintenance shafts 8, 9 allow for installing ladders 29, 20 at the opposing sides of the support frame 18 that are movable into the maintenance shafts 8, 9, the ladders facilitating the execution of maintenance work.

1. A storage lift comprising a plurality of shelf columns (2-5) which lie next to one another and opposite one another on both sides of a conveying shaft (15) whose side walls are provided with support webs (27) arranged at a small distance from each other and one above another for supporting storage material carriers (12), a conveyor (26), which is vertically and horizontally movable in the conveying shaft (15) and provided with a horizontal conveying means and guided in a support frame (18) and by which storage material carriers (12) can be transferred from at least one feeding and retrieving opening (10, 11) to and re-transported from storage places of the shelf columns (2-5) (10, 11) positioned in a shelf column, and a respective light grid (14) provided in the region of the feeding and retrieving openings (10, 11) for determining the height of the storage material (13) to be stored in a height-optimized way, characterized in that the conveyor (26) is supported in a known manner to be movable upwards and downwards in the support frame (18) and that said support frame, on its part, is guided also in a known manner to be movable in horizontal direction on at least two guide rails (16, 17), of which one (16) is connected fixedly to the base (23) of the conveying shaft (15) and one (17) is arranged in the upper region of the conveying shaft (15), and that each of the shelf columns (2-5) has four corner posts (25) and that at least some of the upper ends of the corner posts (25) of opposing shelf columns (e.g. 3a, 3b) are interconnected by transverse carriers (24) which bridge the conveying shaft (15) and which serve to fasten the upper guide rail (17) for guiding the support frame (18).

2. The storage lift according to claim 1, characterized in that the support frame (18) comprises at least two vertical carriers (19, 20) and two horizontal carriers (21, 22) interconnecting said vertical carriers at the top and bottom and running in the longitudinal direction of the conveying shaft (15) and that the vertical carriers (19, 20) are provided with guides for the conveyer (26) which is movable upwards and downwards thereinbetween and carries the storage material (13).

3. The storage lift according to claim 2, characterized in that the parts of the housing (1) completing the opposing ends of the conveying shaft (15) are configured as maintenance shafts (8, 9) into which the vertical carrier (19 or 20) of the support frame (18) which respectively faces said shafts is movable.

4. The storage lift according to claim 3, characterized in that the maintenance shafts (8, 9) extend over the whole height and depth of the housing (1).

5. The storage lift according to claim 3, characterized in that the support frame (18) is provided on at least one of its sides facing the maintenance shafts (8, 9) with a ladder (29, 30) which extends over approximately the whole height of the housing (1) and can be transferred into the region of a maintenance shaft (8 or 9, respectively).

6. The storage lift according to claim 1, characterized in that it comprises any desired number of adjacently arranged pairs of opposing shelf columns (2-5).

7. The storage lift according to claim 2, characterized in that the conveyor (26) is supported on the vertical carriers (19, 20) at its opposing sides via at least two respective spaced-apart and arranged one above another pairs of guide rolls (28).

8. The storage lift according to claim 4, characterized in that the support frame (18) is provided on at least one of its sides facing the maintenance shafts (8, 9) with a ladder (29, 30) which extends over approximately the whole height of the housing (1) and can be transferred into the region of a maintenance shaft (8 or 9, respectively).

9. The storage lift according to claim 2, characterized in that it comprises any desired number of adjacently arranged pairs of opposing shelf columns (2-5).

10. The storage lift according to claim 3, characterized in that it comprises any desired number of adjacently arranged pairs of opposing shelf columns (2-5).

11. The storage lift according to claim 4, characterized in that it comprises any desired number of adjacently arranged pairs of opposing shelf columns (2-5).

12. The storage lift according to claim 5, characterized in that it comprises any desired number of adjacently arranged pairs of opposing shelf columns (2-5).

13. The storage lift according to claim 8, characterized in that it comprises any desired number of adjacently arranged pairs of opposing shelf columns (2-5).

14. The storage lift according to claim 3, characterized in that the conveyor (26) is supported on the vertical carriers (19, 20) at its opposing sides via at least two respective spaced-apart and arranged one above another pairs of guide rolls (28).

15. The storage lift according to claim 4, characterized in that the conveyor (26) is supported on the vertical carriers (19, 20) at its opposing sides via at least two respective spaced-apart and arranged one above another pairs of guide rolls (28).

16. The storage lift according to claim 5, characterized in that the conveyor (26) is supported on the vertical carriers (19, 20) at its opposing sides via at least two respective spaced-apart and arranged one above another pairs of guide rolls (28).

17. The storage lift according to claim 6, characterized in that the conveyor (26) is supported on the vertical carriers (19, 20) at its opposing sides via at least two respective spaced-apart and arranged one above another pairs of guide rolls (28).

18. The storage lift according to claim 8, characterized in that the conveyor (26) is supported on the vertical carriers (19, 20) at its opposing sides via at least two respective spaced-apart and arranged one above another pairs of guide rolls (28).

19. The storage lift according to claim 9, characterized in that the conveyor (26) is supported on the vertical carriers (19, 20) at its opposing sides via at least two respective spaced-apart and arranged one above another pairs of guide rolls (28).

20. The storage lift according to claim 10, characterized in that the conveyor (26) is supported on the vertical carriers (19, 20) at its opposing sides via at least two respective spaced-apart and arranged one above another pairs of guide rolls (28).
